(19) United States
(12) Patent Application Publication
(10) Pub. No.: US 2016/0192405 A1
(43) Pub. Date: Jun. 30, 2016

(54) APPARATUS, METHOD AND SYSTEM OF MAPPING A WIRELESS LOCAL AREA NETWORK ACCESS POINT TO A SINK DEVICE

(71) Applicant: INTEL CORPORATION, Santa Clara, CA (US)

(72) Inventors: Krishnan Rajamani, San Diego, CA (US); Narjala Bhasker, Portland, OR (US); Shriharsha S. Hegde, Portland, OR (US); Carl C. Hansen, Aloha, OR (US); Charles L. Brabenac, Portland, OR (US)

(21) Appl. No.: 14/582,842

(22) Filed: Dec. 24, 2014

(51) Int. Cl. H04W 76/02; H04W 48/16; H04L 29/06; H04L 29/08

(52) U.S. Cl. CPC H04W 76/02; H04L 67/1061; H04W 48/16; H04L 65/608; H04W 84/12

(57) ABSTRACT

Some demonstrative embodiments include devices, systems and methods of mapping a wireless local area network access point to a sink device. For example, a source device may include a radio to establish a peer to peer connection over a wireless communication channel between the source device and a sink device, the peer to peer connection to communicate from the source device to the sink device content to be displayed on a display device; and a controller to receive mapping information to map the sink device to a WLAN AP, the controller to communicate WLAN traffic with the WLAN AP during the peer to peer connection.

### TECHNICAL FIELD

Embodiments described herein generally relate to mapping a Wireless Local Area Network (WLAN) Access Point (AP) to a sink device.

### BACKGROUND

Wireless Fidelity (Wi-Fi) display technology enables streaming data, e.g., music, videos, photos, presentations, and/or any other data, from a communication device, e.g., a laptop, a tablet, and/or the like, to a display device, e.g., a television display, a projector, and/or the like.

Wi-Fi display technology uses a Wi-Fi Direct connection to stream the data to the display device.

However, in some systems the Wi-Fi Direct connection may not be the best and/or most efficient connection.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative embodiments.

FIG. 2 is a schematic illustration of a connectivity scheme, in accordance with some demonstrative embodiments.

FIG. 3 is a schematic illustration of a connectivity scheme, in accordance with some demonstrative embodiments.

FIG. 4 is a schematic illustration of a connectivity scheme, in accordance with some demonstrative embodiments.

FIG. 5 is a schematic illustration of a connectivity scheme, in accordance with some demonstrative embodiments.

FIG. 6 is a schematic flow chart illustration of a method of mapping a Wireless Local Area Network (WLAN) Access Point (AP) to a sink device, in accordance with some demonstrative embodiments.

FIG. 7 is a schematic illustration of a product of manufacture, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The word “demonstrative” is used herein to mean “serving as a demonstration, an example, instance, or illustration”. Any embodiment described herein as “demonstrative” is not necessarily to be construed as preferred or advantageous over other embodiments.

Some embodiments may be used in conjunction with various devices and systems, for example, a User Equipment (UE), a Mobile Device (MD), a wireless Station (STA), a communication station, an access terminal, a communication node, an Access Point (AP), an access node, a Personal Computer (PC), a desktop computer, a mobile computer, a laptop computer, a notebook computer, an Ultrabook™ computer, a tablet computer, a server computer, a handheld computer, a handheld device, a Personal Digital Assistant (PDA) device, a handheld PDA device, a Bluetooth (BT) device, a Bluetooth Low Energy (BLE) device, an on-board device, an off-board device, a hybrid device, a vehicular device, a non-vehicular device, a mobile or portable device, a consumer device, a non-mobile or non-portable device, a wireless communication station, a wireless communication device, a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing IEEE 802.11 standards (IEEE 802.11-2012, IEEE Standard for Information technology—Telecommunications and information exchange between systems Local and metropolitan area networks—Specific requirements Part 11: Wireless LAN Medium Access Control (MAC) and Physical Layer (PHY) Specifications, Mar. 29, 2012; IEEE802.11ac (“IEEE P802.11ac-2013, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 4: Enhancements for Very High Throughput for Operation in Bands below 6 GHz”, December, 2013”); IEEE 802.11ad (“IEEE P802.11ad-2012, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band”, 28 Dec. 2012); and/or IEEE 802.11ax (High-Efficiency Wi-Fi (HEW)) and/or future versions and/or derivatives thereof, devices and/or networks operating in accordance with existing Wireless-Gigabit-Alliance (WGA) specifications (Wireless Gigabit Alliance, Inc WiGig MAC and PHY Specification Version 1.1, April 2011, Final specification) and/or future versions and/or derivatives thereof, devices and/or networks operating in accordance with existing Wireless Fidelity (WiFi) Alliance (WFA) Peer-to-Peer (P2P) specifications (WiFi P2P technical specification, version 1.2, 2012; and/or WiFi Direct Services (WFDS) 2.0) and/or future versions and/or derivatives thereof, devices and/or networks operating in accordance with existing cellular specifications and/or protocols, e.g., 3rd Generation Partnership Project (3GPP), 3GPP Long Term Evolution (LTE), and/or future versions and/or derivatives thereof, units and/or devices which are part of the above networks, and the like.

Some embodiments may be used in conjunction with one way and/or two-way radio communication systems, multi-radio devices, cellular radio-telephone communication systems, an access terminal, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, a Mobile Internet Device (MID), or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Orthogonal Frequency-Division Multiple Access (OFDMA), Spatial Divisional Multiple Access (SDMA), Multi-User (MU) MIMO (MU-MIMO), Single Carrier Frequency-Division Multiple Access (SC-FDMA), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), BT, BLE, Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, High-Speed Downlink Packet Access (HSDPA), High-Speed Uplink Packet Access (HSUPA), High-Speed Packet Access (HSPA), HSPA+, Single Carrier Radio Transmission Technology (1×RTT), Evolution-Data Optimized (EV-DO), Enhanced Data rates for GSM Evolution (EDGE), and the like. Other embodiments may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb “communicating” may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device.

Some demonstrative embodiments may be used in conjunction with a WLAN, e.g., a Wireless Fidelity (Wi-Fi or WiFi) network, a WFD network, a WFDS network, or a WLAN according to the IEEE 802.11 Standards (also referred to as “the 802.11 network”). Other embodiments may be used in conjunction with any other suitable wireless communication network, for example, a wireless area network, a “piconet”, a WPAN, a WVAN and the like.

The term “antenna”, as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a set of switched beam antennas, and/or the like.

The term “station” (STA), as used herein, may include any logical entity that is a singly addressable instance of a medium access control (MAC) and a physical layer (PHY) interface to a wireless medium (WM).

The phrase “access point” (AP), as used herein, may include an entity that contains one station (STA) and provides access to distribution services, via the WM for associated STAs.

The phrase “non-access-point (non-AP) station (STA)”, as used herein, may relate to a STA that is not contained within an AP.

The phrase “peer to peer (PTP) communication”, as used herein, may relate to device-to-device communication over a wireless link (“peer-to-peer link”) between devices. The PTP communication may include, for example, a WiFi Direct (WFD) communication, e.g., a WFD Peer to Peer (P2P) communication, wireless communication over a direct link within a QoS basic service set (BSS), a tunneled direct-link setup (TDLS) link, a STA-to-STA communication in an independent basic service set (IBSS), or the like.

Some demonstrative embodiments are described herein with respect to the wireless communication over the direct link within the QoS BSS. However, other embodiments may be implemented with respect to any other peer to peer communication scheme, network, standard and/or protocol.

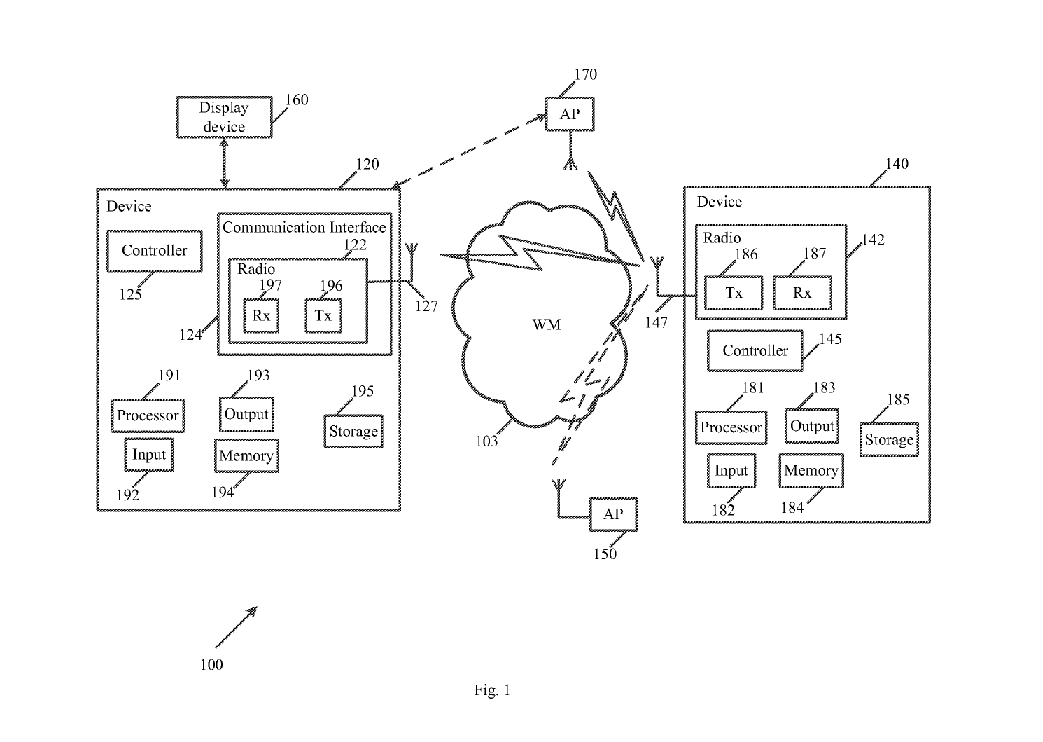

Reference is now made to FIG. 1, which schematically illustrates a block diagram of a system 100 in accordance with some demonstrative embodiments.

In some demonstrative embodiments, system 100 may include one or more non-AP stations, e.g., client STAs, and one or more APs. For example, system may include devices 120 and/or 140, which may perform the functionality of non-AP stations, and APs 150 and/or 170, e.g., a WiFi AP, an access node, a base station, a router, and/or the like.

In some demonstrative embodiments, system 100 may include a display device 160 to display content, e.g., a video content, a presentation content, a graphic content, an image content, a media content, and/or the like.

In some demonstrative embodiments, display device 160 may be implemented as part of device 120. For example, device 120 may include an all in one (AIO) computing device, a smart board, and/or the like.

In some demonstrative embodiments, display device 160 and device 120 may be implemented as separate elements of system 100. For example, device 120 may include a Wi-Fi display adapter, a personal computer, a server, and/or the like, connected to display device 160. For example, device 160 may include a projector, a plasma TV, an LCD display, and/or the like.

In some demonstrative embodiments, device 140 may perform the functionality of a source device; and/or device 120 may perform functionality of a sink device, e.g., as described below.

In some demonstrative embodiments, device 120 may include a mobile or a non-mobile device, e.g., a static device. For example, device 120 may include a Miracast sink, a Wireless Display (WiDi) sink, a data sink, a User Equipment (UE), a Mobile Device (MD), a mobile station, an access terminal, an Internet of Things (IoT) device, a subscriber station, a High Data Rate (HDR) subscriber station, a mobile computer, PC, a desktop computer, a laptop computer, a notebook computer, a tablet computer, a server computer, a handheld computer, an Ultrabook™ computer, a mobile internet device, a handheld device, a source device, a destination device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a context-aware device, a video device, an audio device, an A/V device, a Set-Top-Box (STB), a video source, an audio source, a video sink, an audio sink, a stereo tuner, a broadcast radio receiver, a flat panel display, a Personal Media Player (PMP), or the like.

In some demonstrative embodiments, device 140 may include, for example, a mobile device. For example, device 140 may include a Miracast source, a WiDi source, a data source, a UE, a MD, a mobile station, an access terminal, an IoT device, a subscriber station, a HDR subscriber station, a mobile computer, a laptop computer, a notebook computer, a tablet computer, an Ultrabook™ computer, a mobile internet device, a handheld computer, a handheld device, a storage device, a PDA device, a handheld PDA device, an on-board device, an off-board device, a hybrid device, a consumer device, a vehicular device, a non-vehicular device, a portable device, a mobile phone, a cellular telephone, a PCS device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), an “Origami” device or computing device, a video device, an audio device, an A/V device, a gaming device, a media player, a Smartphone, or the like.

In some demonstrative embodiments, device 120 may also include, for example, a processor 191, an input unit 192, an output unit 193, a memory unit 194, and/or a storage unit 195; and/or device 140 may also include, for example, a processor 181, an input unit 182, an output unit 183, a memory unit 184, and/or a storage unit 185. Devices 120 and/or 140 may optionally include other suitable hardware components and/or software components. In some demonstrative embodiments, some or all of the components of devices 120 and/or 140 may be enclosed in a common housing or packaging, and may be interconnected or operably associated using one or more wired or wireless links. In other embodiments, components of devices 120 and/or 140 may be distributed among multiple or separate devices.

Processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. For example, processor 191 executes instructions, for example, of an Operating System (OS) of device 120 and/or of one or more suitable applications; and/or processor 181 executes instructions, for example, of an Operating System (OS) of device 140 and/or of one or more suitable applications.

Memory unit 194 and/or memory unit 184 may include, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a floppy disk drive, a Compact Disk (CD) drive, a CD-ROM drive, a DVD drive, or other suitable removable or non-removable storage units. For example, memory unit 194 and/or storage unit 195, for example, may store data processed by device 120; and/or memory unit 184 and/or storage unit 185, for example, may store data processed by device 140.

Input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative embodiments, device 140 may include one or more wireless communication units to perform wireless communication between device 140 and AP 170, AP 150, and/or one or more other wireless communication devices, e.g., device 120. For example, device 140 may include at least one radio 142, e.g., including at least one transmitter (Tx) 186, and at least one receiver (Rx) 187. For example, AP 170, and/or AP 150 may include a WLAN AP, and radio 142 may include a WLAN radio configured to communicate over a WLAN.

In some demonstrative embodiments, device 120 may include a communication interface 124 to perform communication between device 120 and AP 170, AP 150, and/or one or more other wired and/or wireless communication devices, e.g., device 140.

In one example, communication interface 124 may perform a wireless communication between device 120 and AP 170, AP 150, and/or device 140. Additionally or alternatively, communication interface 124 may perform a wired communication between device 120 and AP 170, and/or AP 150. In another example, communication interface 124 may perform any other type of communication with any other device.

In some demonstrative embodiments, communication interface 124 may include a radio 122 to communicate via a wireless link. Additionally or alternatively, communication interface 124 may include any other communication unit, e.g., a modulator-demodulator (Modem) to communicate over a wired link.

In some demonstrative embodiments, radio 122 may include at least one transmitter (Tx) 196, and at least one receiver (Rx) 197.

In some demonstrative embodiments, Tx 186, Tx 196, Rx 187, and/or Rx 197 may be configured to communicate wireless communication signals, RF signals, blocks, transmission streams, frames, messages, data items, and/or data. In one example, Tx 186, Tx 196, Rx 187, and/or Rx 197 may include circuitry, logic, modulation elements, demodulation elements, amplifiers, analog to digital and/or digital to analog converters, filters, RF circuitry, Base Band (BB) circuitry, and/or the like. For example, Tx 186, Tx 196, Rx 187, and/or Rx 197 may include or may be implemented as part of a transceiver, a wireless Network Interface Card (NIC), and the like.

In some demonstrative embodiments, radio 142 may include, or may be associated with, one or more antennas. For example, radio 142 may be associated with one or more antennas 147, e.g., a single antenna or two or more antennas.

In some demonstrative embodiments, radio 122 may include, or may be associated with, one or more antennas. For example, radio 122 may be associated with one or more antennas 127, e.g., a single antenna or two or more antennas.

Antennas 127 and/or 147 may include any type of antennas suitable for transmitting and/or receiving wireless communication signals, blocks, transmission streams, frames, messages and/or data. For example, antennas 127 and/or 147 may include any suitable configuration, structure and/or arrangement of one or more antenna elements, components, units, assemblies and/or arrays. Antennas 127 and/or 147 may include, for example, antennas suitable for directional communication, e.g., using beamforming techniques. For example, antennas 127 and/or 147 may include a phased array antenna, a multiple element antenna, a set of switched beam antennas, and/or the like. In some embodiments, antennas 127 and/or 147 may implement transmit and receive functionalities using separate transmit and receive antenna elements. In some embodiments, antennas 127 and/or 147 may implement transmit and receive functionalities using common and/or integrated transmit/receive elements.

In some demonstrative embodiments, device 120, device 140, AP 170, and/or AP 150 may communicate content, data, information and/or signals over a wireless medium (WM) 103.

In some demonstrative embodiments, WM 103 may include, for example, an RF channel, a Wi-Fi channel, a wireless display channel, a WiDi channel, a WLAN channel, a Bluetooth (BT) channel, a radio channel, a cellular channel, an IR channel, a GNSS channel, a Near Field Communication (NFC) channel, a Hybrid Digital Radio (HDR) channel, a Frequency Modulation (FM) channel, and/or the like.

In some demonstrative embodiments, device 120 and AP 170 may optionally be capable of communicating via one or more wired links and/or networks, e.g., as described below.

In some demonstrative embodiments, at least one of devices 120 and 140 may include a wireless communication device configured to communicate with AP 170 and/or AP 150 via a wireless communication link, e.g., as described below. One or more elements of system 100 may optionally be capable of communicating over any suitable wired communication links, e.g., as described below.

In some demonstrative embodiments, device 140 may discover device 120 in proximity of device 140.

In one example, device 140 may discover device 120 according to a Universal Plug and Play (UPnP) protocol, a Multicast Domain Name System (mDNS) protocol, a Miracast technology protocol, a Wi-Fi Direct protocol, and/or the like.

In another example, device 140 may discover device 120 via out-of-band proximity discovery techniques, e.g., NFC, BLE, Ultrasound, Lync, Outlook naming convention, and/or the like.

In another example, device 140 may discover device 120 via any other techniques, and/or protocols.

In some demonstrative embodiments, devices 120 and/or 140 may establish a peer-to-peer connection over a wireless communication channel between device 140 and device 120 to communicate content from device 140 to device 120 to be displayed on display device 160, e.g., as described below.

For example, device 140 may include a laptop, device 120 may include a WiDi adapter, and display device 160 may include a projector display. According to this example, the WiDi adapter may receive a video content from the laptop to display the video content by the projector display.

In some demonstrative embodiments, device 140 may operate over a first frequency channel to communicate with device 120, and device 140 may operate over a second frequency channel, different from the first frequency channel, to communicate with a WLAN AP.

For example, the laptop may stream data to the WiDi adapter over the first frequency channel, and the laptop may connect to the WLAN AP over the second frequency channel.

In some demonstrative embodiments, radio 142 and/or radio 122 may perform frequent switching between the first and second frequency channels, for example, to enable device 120, device 140, and/or the WLAN AP to communicate over the first and second frequency channels.

In some demonstrative embodiments, the frequent switching of radio 142, and/or radio 122 between the different frequency channels may increase a power consumption of device 140 and/or device 120.

Some demonstrative embodiments may be configured to enable device 140, device 120 and/or the WLAN AP to operate over the same frequency channel. According to these embodiments, the use of a multiple-channel link between device 140, device 120, and/or the WLAN AP may be eliminated, e.g., as described below.

In some demonstrative embodiments, eliminating the use of the multiple-channel link between the source device, the sink device, and/or the WLAN AP may improve a performance of data streaming between the source device and the sink device, e.g., as described below.

In some demonstrative embodiments, device 120 may be mapped to a proximal WLAN AP, for example, AP 170, e.g., as described below.

In some demonstrative embodiments, the proximal WLAN AP may include an AP in close range of device 120, which may be logically associated with device 120.

For example, a BSSID of device 120 may be logically mapped to a BSSID of the proximal WLAN AP, e.g., by an Information Technology (IT) team, a user of device 120, and/or the like.

In some demonstrative embodiments, a mapping between the sink device, e.g., device 120, and the proximal WLAN AP, e.g., AP 170, may include a one to one mapping. For example, the mapping may map a single sink device, e.g., device 120, to a single WLAN AP, e.g., AP 170.

In some demonstrative embodiments, device 120 may be connected to AP 170 via a wired link, for example, if the mapping includes the one to one mapping.

For example, device 120 and AP 170 may be optionally integrated and/or collocated, e.g., via a high-speed bus, and/or any other private interconnect.

In some demonstrative embodiments, the mapping between device 120 and AP 170 may include a multiple to one mapping. For example, the mapping may map two or more sink devices, e.g., device 120 and/or one or more other sink devices, to the single WLAN AP, e.g., AP 170.

For example, two or more sink devices may be connected to AP 170 via a switched Ethernet link, a Wi-Fi link, and/or any other connection.

In some demonstrative embodiments, device 120 and/or the one or more other sink devices may remain associated with the mapped WLAN AP, for example, if two or more sink devices are connected to AP 170 via the Wi-Fi link.

In some demonstrative embodiments, the mapping between device 120 and AP 170 may enable designation of the frequency channel for display device 160 traffic, e.g., based on a desired spectrum partitioning policies.

For example, the mapping between device 120 and AP 170 may enable, e.g., the IT team, to partition, and/or manage a use of a WLAN spectrum across display device 160, e.g., in order to reduce a WLAN traffic load of the frequency channel of display device 160.

In some demonstrative embodiments, AP 170 may be configured to dynamically reassign the frequency channels, e.g., by the IT team.

In some demonstrative embodiments, device 120 may be configured to track changes of the frequency channels of AP 170 in order to remain associated with the mapped BSS, e.g., the BSS of AP 170.

For example, device 120 may track changes of the frequency channels of AP 170 via one or more protocols, e.g., 802.11 ECS protocol.

In some demonstrative embodiments, a mapping of AP 170 in tandem with device 120 functioning as a P2P Group Owner (GO) may ensure that both AP 170 and device 120 are operating on the same frequency channel.

In some demonstrative embodiments, device 140 may include a controller 145 configured to receive mapping information to map the sink device, e.g., device 120, to the proximal WLAN AP, e.g., AP 170.

In one example, the mapping information may include a mapping between an identifier of the sink device, e.g., the BSSID of device 120, and an identifier of the proximal WLAN AP, e.g., the BSSID of AP 170.

In another example, the mapping information may include any other information.

In some demonstrative embodiments, device 140 may include a memory, e.g., memory 184, to store the mapping information.

In some demonstrative embodiments, controller 145 may receive the mapping information prior to establishment of the peer-to-peer connection between device 140 and device 120, e.g., as described below.

In one example, controller 145 may receive the mapping information from a server prior to establishment of the peer-to-peer connection between device 140 and device 120.

For example, device 140 may obtain the mapping information, e.g., a BSSID mapping, by connecting to an IT server via the Wi-Fi connection.

In another example, controller 145 may be mass-provisioned with the mapping information prior to establishment of the peer-to-peer connection between device 140 and device 120.

For example, device 140 may be mass-provisioned with the mapping information by the IT team, and device 140 may store the mapping information in memory 184.

In some demonstrative embodiments, receiving the mapping information prior to establishment of the peer-to-peer connection between device 140 and device 120 may enable device 140 to eliminate the multiple-channel link between device 140, device 120, and/or AP 170.

For example, connecting to the proximal WLAN AP, e.g., AP 170, may enable device 140 to operate on the same frequency channel for both the peer-to-peer connection with device 120, and/or an access to AP 170, e.g., based on the mapping information.

In some demonstrative embodiments, controller 145 may receive the mapping information after the establishment of the peer-to-peer connection between device 140 and device 120, e.g., as described below.

In some demonstrative embodiments, device 120 may include a controller 125 configured to generate a message including mapping information mapping device 120 to the proximal WLAN AP, e.g., AP 170.

In some demonstrative embodiments, controller 125 may send the mapping information to device 140.

In one example, controller 125 may send the mapping information via the peer-to-peer connection with device 140.

In some demonstrative embodiments, the mapping information may be included in a proximity discovery message.

For example, controller 125 may generate a discovery frame including the proximity discovery message, and communication interface 124 may transmit the discovery frame to device 140.

In some demonstrative embodiments, the proximity discovery message may include a peer-to-peer proximity discovery message. For example, communication interface 124 may send the proximity discovery message via the peer-to-peer connection with device 140, e.g., via radio 122.

In other demonstrative embodiments, the proximity discovery message may include an NFC proximity discovery message, a BLE proximity discovery message, an Ultrasound proximity discovery message, and/or any other type of proximity discovery message according to any other proximity discovery mechanism.

In some demonstrative embodiments, communication interface 124 may include one or more radios configured to transmit the proximity discovery message.

For example, communication interface 124 may include an NFC radio, a BLE radio, and/or any other type of radio.

In other demonstrative embodiments, the NFC radio, the BLE radio, and/or any other element configured to transmit the proximity discovery message according to the proximity discovery mechanism may be implemented as an external element, which may be connected to device 120.

In some demonstrative embodiments, the mapping information may be included in a real time streaming protocol (RTSP) message.

For example, controller 125 may generate a RTSP frame including the RTSP message, and communication interface 124 may transmit the RTSP frame to device 140.

In some demonstrative embodiments, controller 145 may receive the mapping information from device 120.

In some demonstrative embodiments, device 140 may receive the mapping information from device 120 via radio 142. For example, device 140 may receive the mapping information via the peer-to-peer connection with device 120.

In some demonstrative embodiments, controller 145 may receive the mapping information after the establishment of the peer-to-peer connection between device 140 and device 120, for example, if the mapping information is not known prior to the establishment of the peer-to-peer connection.

In some demonstrative embodiments, device 140 may connect to device 120 over the first frequency channel, and to the WLAN AP, e.g., AP 150, over the second frequency channel, for example, if the mapping information is not known to device 140 prior to the establishment of the peer-to-peer connection.

For example, device 140 may be connected to AP 150 over the second frequency channel, and device 140 may connect to device 120 over the first frequency channel, e.g., prior to receiving the mapping information.

In some demonstrative embodiments, device 140 may receive the mapping information directly from device 120, e.g., via a Wi-Fi Direct connection, after the establishment of the peer-to-peer connection between device 140 and device 120.

For example, device 140 may establish the Wi-Fi Direct connection to receive the mapping information, and device 140 may switch from the Wi-Fi Direct connection over the first frequency channel to the peer-to-peer connection over the second frequency channel between device 140 and device 120, for example, after receiving the mapping information via the Wi-Fi Direct connection, and before communicating content to device 120.

In some demonstrative embodiments, device 140 may communicate WLAN traffic with the WLAN AP during the peer-to-peer connection.

For example, the WLAN traffic may include video content, audio content, AV content, and/or the like.

In some demonstrative embodiments, controller 145 may communicate the WLAN traffic with another WLAN AP prior to establishing the peer-to-peer connection between device 140 and device 120.

For example, device 140 may communicate with AP 150 prior to establishing the peer-to-peer connection between device 140 and device 120.

In some demonstrative embodiments, controller 145 may be configured to communicate the WLAN traffic only with the proximal WLAN AP, e.g., AP 170, during the peer-to-peer connection between device 140 and device 120, for example, in order to eliminate the use of multiple-channel links, e.g., as described below.

In some demonstrative embodiments, device 140 may switch between the first frequency channel and the second frequency channel to enable communication of device 140 with both device 120 and AP 170 over the same frequency channel, e.g., as described below.

In some demonstrative embodiments, device 140 may switch from a first WLAN AP to a second WLAN AP to eliminate the use of multiple-channel links, e.g., as described below.

In some demonstrative embodiments, device 140 may switch to the proximal WLAN AP, e.g., AP 170, to ensure that device 140 operates over the same frequency channel for both the peer-to-peer connection with device 120, and the access to the WLAN, e.g., as described below.

In some demonstrative embodiments, controller 145 may be configured to switch from another WLAN AP, e.g., AP 150, to the proximal WLAN AP, e.g., AP 170.

For example, controller 145 may switch from AP 150 to AP 170, when establishing the peer-to-peer connection between device 140 and device 120.

In some demonstrative embodiments, controller 145 may switch to AP 170 and establish the WLAN link with AP 170, e.g., based on the mapping information.

For example, controller 145 may connect to device 120 via Internet Protocol (IP), WLAN, and/or Wi-Fi Direct to receive the mapping information, may obtain the BSSID of AP 170 from the mapping information, may locally force a BSS roam of device 140 to AP 170, which is mapped to device 120, and may lock to the BSS of AP 170, e.g., while transferring the content to device 120.

In some demonstrative embodiments, the proximal WLAN AP, e.g., AP 170, may be configured to control the WLAN traffic traversing AP 170 according to association control criteria, e.g., as described below.

For example, the association control criteria may be configured to improve managing the Wi-Fi spectrum, and/or AV performance of display device 160.

In some demonstrative embodiments, the IT team may control a STA load and/or the WLAN traffic traversing AP 170, for example, if AP 170 operates according to the association control criteria, e.g., as described below.

In some demonstrative embodiments, AP 170 may be controlled, e.g., by the IT team, to decide whether to allow a STA, e.g., device 140, to connect with AP 170.

For example, AP 170 may allow device 140 to connect with AP 170, for example, only if device 140 is connected with device 120, which is mapped to AP 170.

In some demonstrative embodiments, AP 170 may limit a number of the source devices, which may simultaneously connect to device 120 for rapid switching at device 120.

In one example, a number of the source devices permitted to connect to AP 170 may be predefined prior to establishing the connection between AP 170 and the source devices, e.g., by the IT team.

In another example, the number of the source devices permitted to connect to AP 170 may be dynamically determined according to the association control criteria.

In another example, the number of the source devices permitted to connect to AP 170 may be determined in any other technique.

In some demonstrative embodiments, a forced WLAN roaming of device 140 to AP 170 may ensure that device 140 is operating over a single-channel single-BSS Wi-Fi link for both the peer to peer connection with device 120, and/or the access to the WLAN.

In some demonstrative embodiments, operating device 140, device 120, and/or AP 170 over the same frequency channel may eliminate a dependency of device 140 on a Wi-Fi Direct link to connect to device 120.

In some demonstrative embodiments, eliminating the dependency on the Wi-Fi Direct link may improve a robustness of connectivity between device 120 and device 140, may reduce an AV latency of display device 160, may preserve a WLAN throughput, and/or may enable a WLAN power-save for display device 160 traffic.

In some demonstrative embodiments, eliminating the Wi-Fi Direct dependency may eliminate connectivity exceptions, e.g., which may be implied by 5 GHz Regulatory constraints.

For example, eliminating connectivity exceptions related to Wi-Fi channels may provide a robust connectivity between device 140 and device 120.

In some demonstrative embodiments, eliminating the Wi-Fi Direct dependency may enable a connection of two or more source devices to the single sink device, e.g., device 120, for example, without imposing a P2P GO status on the sink device.

For example, eliminating the Wi-Fi Direct dependency may facilitate a managed meeting, e.g., two or more source devices sharing an access to device 120, for example, during a meeting in a conference room.

For example, enabling device 120 not to perform the functionality of the P2P GO may eliminate the use of the multiple channel connection between device 120, device 140, and/or AP 170.

In some demonstrative embodiments, eliminating the Wi-Fi Direct dependency may increase available security, and/or enable mass-provisioning.

For example, eliminating the Wi-Fi Direct dependency may eliminate a dependency on a Wi-Fi Protected Setup (WPS), and/or may enable using any other security configuration for the connection between device 140 and device 120.

For example, eliminating the WPS dependency may facilitate mass provisioning of device 140 and/or one or more other source devices with Enterprise-grade security access to device 120.

In some demonstrative embodiments, operating device 140, device 120, and/or AP 170 over the same frequency channel may optimize a Wi-Fi spectrum management, a load balancing, and/or the like.

For example, the roaming of device 140 to AP 170 may enable the IT team to increase and/or optimize management, and/or partition of Wi-Fi spectrum.

In some demonstrative embodiments, the roaming of device 140 to AP 170 may ensure performance advantages of a one-hop short range Wi-Fi connection between device 140 and device 120, e.g., regardless of a link topology between device 120 and AP 170.

For example, the use of the one-hop short range Wi-Fi connection between device 140 and device 120 may reduce a Wi-Fi channel load, and/or increase a quality of an AV performance of display device 160.

In some demonstrative embodiments, the roaming of device 140 to AP 170 may ensure a convergence of device 140 and device 120 on the same BSS, for example, when device 120 and AP 170 are connected via the wireless link.

For example, the convergence of device 140 and device 120 on the same BSS of AP 170 may enable establishing a TDLS link, and/or a same channel Wi-Fi Direct link between device 140 and device 120, for example, in an environment with multiple WLAN APs, and/or a multi-band AP.

In some demonstrative embodiments, the roaming of device 140 to AP 170 may ensure an efficient and/or deterministic path for the WLAN traffic from device 140 to device 120, for example, when device 120 and AP 170 are connected via the wired link.

In some demonstrative embodiments, the mapping between device 120 and AP 170 may provide to system 100 advantages of both an infra networking, and/or a Wi-Fi Direct system, e.g., as described below.

In some demonstrative embodiments, the mapping between device 120 and AP 170 may provide the robust connectivity between device 140 and device 120, may provide a simplicity of the single-channel single-BSS Wi-Fi link between device 140 and device 120, may enable providing the Enterprise-grade security for one or more source devices, and/or may provide mass-provisioning for one or more source devices.

In some demonstrative embodiments, the mapping between device 120 and AP 170 may increase the AV performance of display device 160, may provide a channel utilization efficiency of the one-hop short-range Wi-Fi connection, may improve a Wi-Fi spectrum manageability, and/or may improve a load balancing.

In some demonstrative embodiments, the mapping between device 120 and AP 170 may be implemented using one or more connectivity schemes, e.g., as described below.

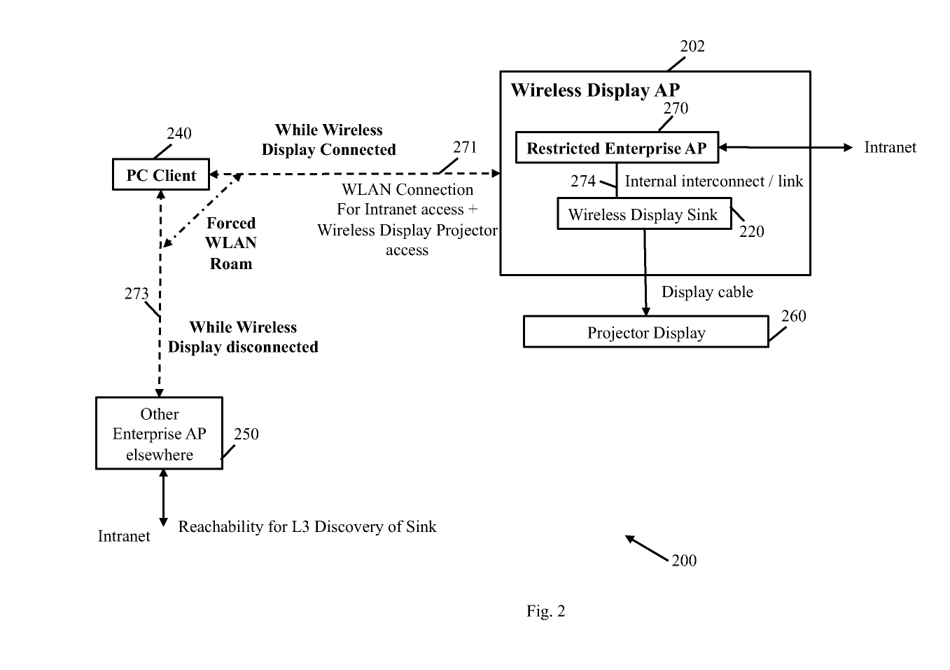

In some demonstrative embodiments, a connection between device 120 and AP 170 may be established via a wired link, e.g., as described below with reference to FIG. 2.

Reference is made to FIG. 2, which schematically illustrates a connectivity scheme 200 of a one to one mapping between a device 220 and an AP 270, in accordance with some demonstrative embodiments. For example, device 220 may perform the functionality of device 120 (FIG. 1), and/or AP 270 may perform the functionality of AP 170 (FIG. 1).

In some demonstrative embodiments, device 220 may be connected to AP 270 via a wired link, e.g., as described below.

As shown in FIG. 2, device 220 and AP 270 may be physically integrated, and managed as a single device, e.g., a sink-AP device 202. For example, device 220 and AP 270 may be connected via a link 274, which may include a wired link.

As shown in FIG. 2, device 220 may be connected with a display device 260 via a wired link, e.g., via a display cable. For example, display device 260 may perform the functionality of display device 160 (FIG. 1).

In some demonstrative embodiments, a device 240 may connect with device 220 to communicate content to device 220 to be displayed on display device 260. For example, device 240 may perform the functionality of device 140 (FIG. 1).

As shown in FIG. 2, device 240 may communicate with an AP 250 via a wireless link 273, when device 240 and device 220 are disconnected. For example, AP 250 may perform the functionality of AP 150 (FIG. 1).

In some demonstrative embodiments, device 240 may communicate with device 220 via an infrastructure connection. For example, the infrastructure connection may include a connection via a WLAN AP, e.g., AP 270.

As shown in FIG. 2, device 240 may roam to connect to AP 270 via a wireless link 271, for example, when establishing a peer-to-peer connection between device 240 and device 220.

As shown in FIG. 2, device 220, and/or device 240 may operate over a Layer 3 (L3) discovery and/or connection protocol, e.g., UPnP, mDNS, and/or the like.

In some demonstrative embodiments, device 220, and/or device 240 may operate over a Layer 2 (L2) discovery protocol, for example, when device 240 receives mapping information prior to establishment of the peer-to-peer connection between device 240 and device 220.

In some demonstrative embodiments, device 220, and/or device 240 may operate over any control protocol, e.g., Miracast/RTSP, any streaming protocol, e.g., Miracast RTP/MPEG-2 TS, and/or any codecs, e.g., H.264, H.2635, AAC, LPCM.

In some demonstrative embodiments, device 220, and/or device 240 may operate over any other protocol, codec, and/or the like.

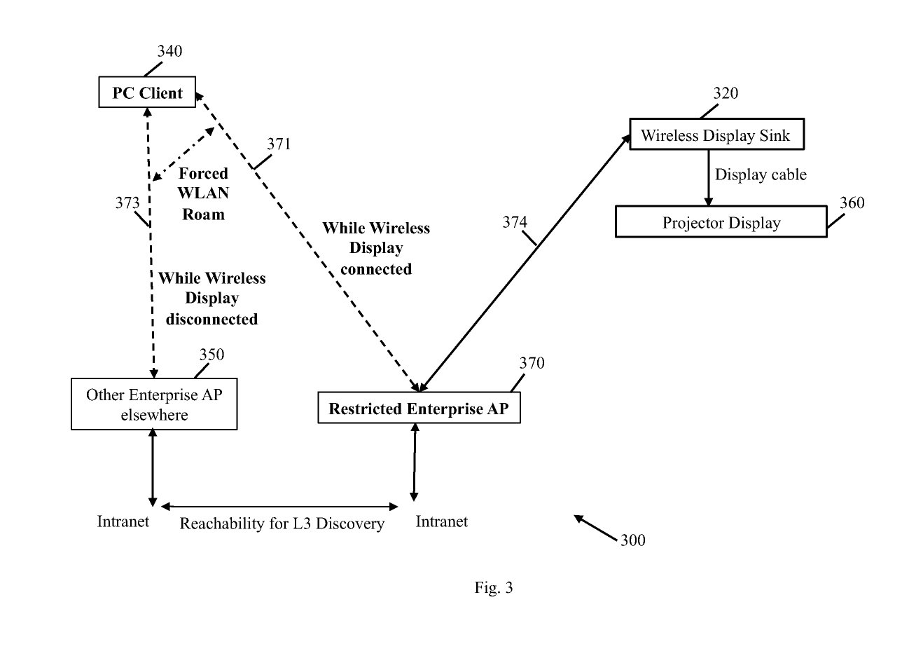

In some demonstrative embodiments, device 120 and AP 170 (FIG. 1) may be implemented by separate elements connected via a wired link, e.g., as described below with reference to FIG. 3.

Reference is made to FIG. 3, which schematically illustrates a connectivity scheme 300 of a mapping between a device 320 and an AP 370, in accordance with some demonstrative embodiments. For example, device 320 may perform the functionality of device 120 (FIG. 1), and/or AP 370 may perform the functionality of AP 170 (FIG. 1).

In some demonstrative embodiments, device 320 and/or one or more other sink devices may be mapped to AP 370, e.g., as described above.

As shown in FIG. 3, device 320 may be connected with AP 370 via a link 374, which may include a wired link, e.g. an Ethernet cable.

As shown in FIG. 3, device 320 and a display device 360 may be connected via a wired link, e.g., a display cable. For example, display device 360 may perform the functionality of display device 160 (FIG. 1).

In some demonstrative embodiments, a device 340 may communicate content to device 320 to be displayed on display device 360. For example, device 340 may perform the functionality of device 140 (FIG. 1).

As shown in FIG. 3, device 340 may communicate with an AP 350 via a wireless link 373, when device 320 and device 340 are disconnected. For example, AP 350 may perform the functionality of AP 150 (FIG. 1).

In some demonstrative embodiments, device 340 may communicate with device 320 via an infrastructure connection. For example, the infrastructure connection may include a connection via a WLAN AP, e.g., AP 370.

As shown in FIG. 3, device 340 may roam to connect to AP 370 via a wireless link 371, for example, when establishing a peer-to-peer connection between device 340 and device 320.

As shown in FIG. 3, device 320, and/or device 340 may operate over a L3 discovery and/or connection protocol, e.g., UPnP, mDNS, and/or the like.

In some demonstrative embodiments, device 320, and/or device 340 may operate over any control protocol, e.g., Miracast/RTSP, any streaming protocol, e.g., Miracast RTP/MPEG-2 TS, and/or any codecs, e.g., H.264, H.2635, AAC, LPCM.

In some demonstrative embodiments, device 320, and/or device 340 may operate over any other protocol.

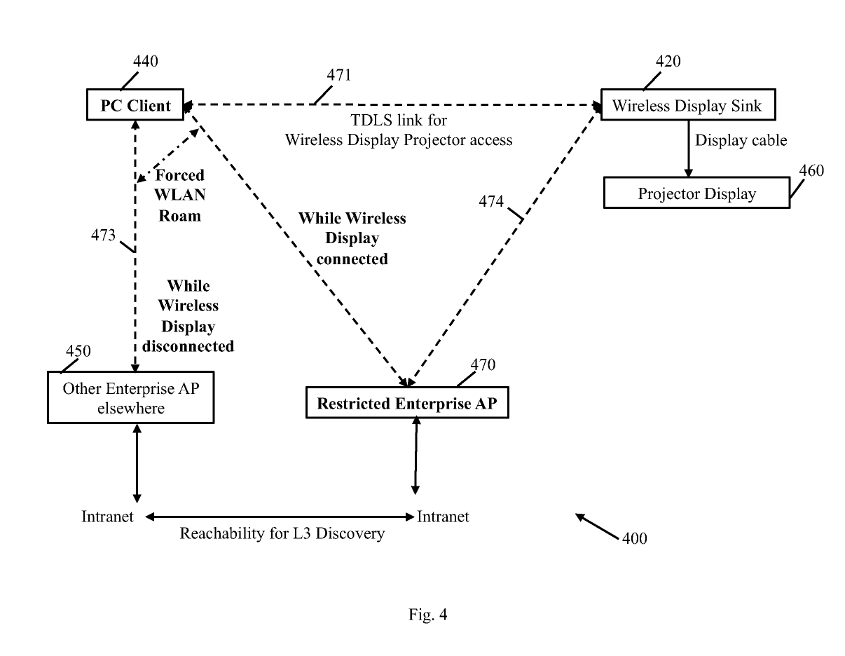

In some demonstrative embodiments, a connection between device 120 and AP 170 (FIG. 1) may be established via a wireless link, e.g., as described below with reference to FIG. 4.

Reference is made to FIG. 4, which schematically illustrates a connectivity scheme 400 of a mapping between a device 420 and an AP 470, in accordance with some demonstrative embodiments. For example, device 420 may perform the functionality of device 120 (FIG. 1), and/or AP 470 may perform the functionality of device 170 (FIG. 1).

In some demonstrative embodiments, device 420 may be managed remotely, e.g., by an IT team via a local network.

In some demonstrative embodiments, device 420 and/or one or more other sink devices may be mapped to AP 470, e.g., as described above.

As shown in FIG. 4, device 420 may be connected with AP 470 via a link 474, which may include a wireless link, e.g., a Wi-Fi link.

As shown in FIG. 4, device 420 and a display device 460 may be connected via a wired link, e.g., a display cable. For example, display device 460 may perform the functionality of display device 160 (FIG. 1).

In some demonstrative embodiments, a device 440 may communicate content to device 420 to be displayed on display device 460. For example, device 440 may perform the functionality of device 140 (FIG. 1).

As shown in FIG. 4, device 440 may communicate with an AP 450 via a wireless link 473, when device 420 and device 440 are disconnected. For example, AP 450 may perform the functionality of AP 150 (FIG. 1).

In some demonstrative embodiments, device 440 may communicate with device 420 via an infrastructure connection. For example, the infrastructure connection may include a connection via a WLAN AP, e.g., AP 470.

As shown in FIG. 4, device 440 may roam to connect to AP 470 via a wireless link 471, for example, in order to establish a TDLS link between device 440 and device 420.

As shown in FIG. 4, device 420, and/or device 440 may operate over L3 discovery and/or connection protocol, e.g., UPnP, mDNS, and/or the like.

In some demonstrative embodiments, device 420, and/or device 440 may operate over any control protocol, e.g., Miracast/RTSP, any streaming protocol, e.g., Miracast RTP/MPEG-2 TS, and/or any codecs, e.g., H.264, H.2635, AAC, LPCM.

In some demonstrative embodiments, device 420, and/or device 440 may operate over any other protocol.

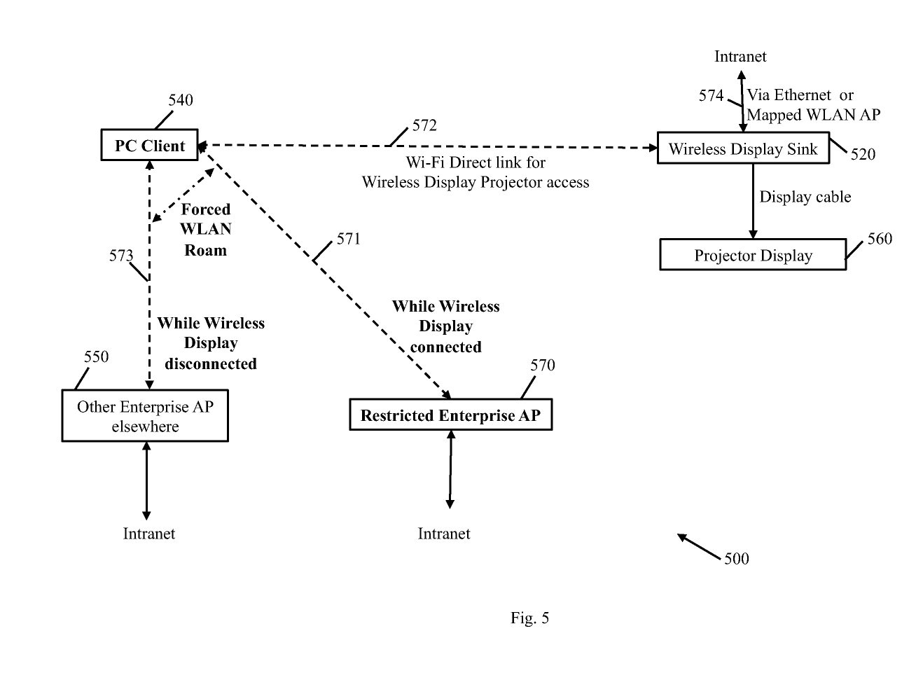

In some demonstrative embodiments, system 100 may be configured to support a Wi-Fi Direct connection between device 120 and device 140 (FIG. 1), e.g., as described below with reference to FIG. 5.

Reference is made to FIG. 5, which schematically illustrates a connectivity scheme 500 of a Wi-Fi Direct implementation of a connection between a device 540 and a device 520, in accordance with some demonstrative embodiments. For example, device 540 may perform the functionality of device 140 (FIG. 1), and/or device 520 may perform the functionality of device 120 (FIG. 1).

In some demonstrative embodiments, device 520 and/or one or more other sink devices may be mapped to an AP 570, e.g., as described above. For example, AP 570 may perform the functionality of AP 170 (FIG. 1).

As shown in FIG. 5, device 520 may be connected to a local network, e.g., Intranet, via a link 574. For example, link 574 may include a wired link, e.g., Ethernet link, and/or a wireless link, e.g., a WLAN link.

As also shown in FIG. 5, device 520 may be connected to the local network, e.g., Intranet, via a mapped WLAN AP, e.g., AP 570.

As shown in FIG. 5, device 520 and a display device 560 may be connected via a wired link, e.g., a display cable. For example, display device 560 may perform the functionality of display device 160 (FIG. 1).

As shown in FIG. 5, device 540 may communicate with an AP 550 via a wireless link 573, when device 520 and device 540 are disconnected. For example, AP 550 may perform the functionality of AP 150 (FIG. 1).

In some demonstrative embodiments, device 540 may receive mapping information from device 520 via a proprietary Wi-Fi Direct (WFD) Information Element (IE) sub-element. For example, device 520 may send the WFD IE sub-element during a discovery phase.

As shown in FIG. 5, device 540 may roam to connect to AP 570 via a wireless link 571, for example, after receiving the mapping information from device 520.

As shown in FIG. 5, device 540 and device 520 may establish a Wi-Fi Direct link 572, for example, to enable streaming content to device 520 to be displayed on display device 560.

In some demonstrative embodiments, device 520, and/or device 540 may operate over any control protocol, e.g., Miracast/RTSP, any streaming protocol, e.g., Miracast RTP/MPEG-2 TS, and/or any codecs, e.g., H.264, H.2635, AAC, LPCM.

In some demonstrative embodiments, device 520, and/or device 540 may operate over any other protocol.

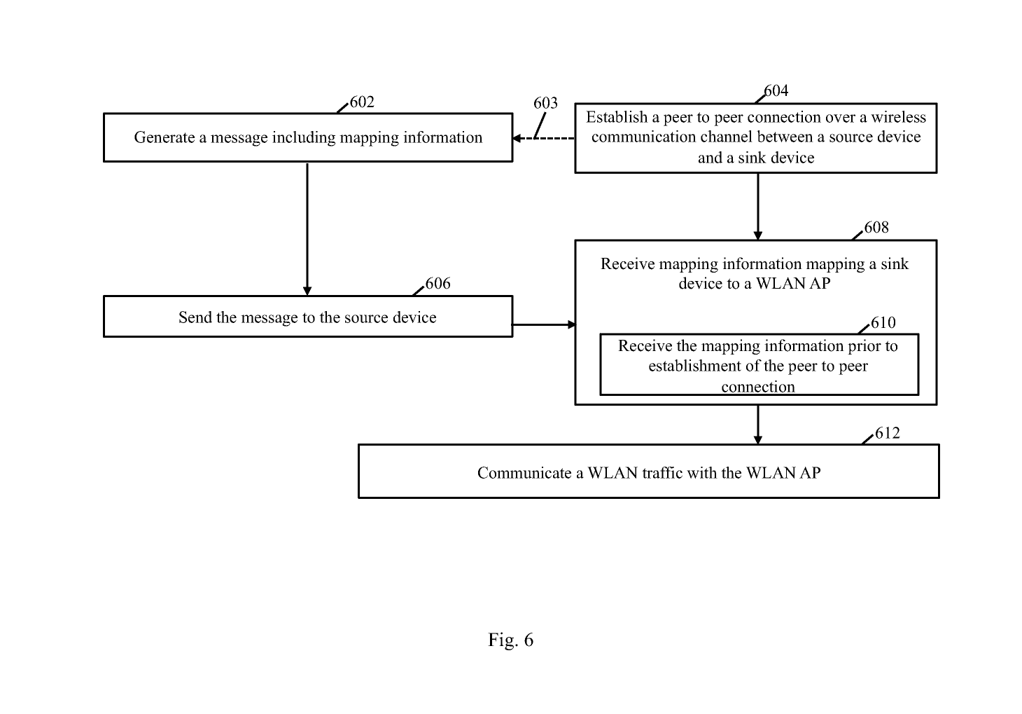

Reference is made to FIG. 6, which schematically illustrates a method of mapping a wireless local area network access point to a sink device, in accordance with some demonstrative embodiments. In some demonstrative embodiments, one or more of the operations of the method of FIG. 6 may be performed by one or more elements of a system, e.g., system 100 (FIG. 1), for example, a device, e.g., device 120 and/or device 140 (FIG. 1); an AP, e.g., AP 170 and/or AP 150; a radio, e.g., radio 122 (FIG. 1) and/or radio 142 (FIG. 1), and/or a controller, e.g., controller 125 (FIG. 1) and/or controller 145 (FIG. 1).

As indicated at block 604, the method may include establishing a peer-to-peer connection over a wireless communication channel between a source device and a sink device. For example, radio 142 (FIG. 1) and/or radio 122 (FIG. 1) may establish the peer-to-peer connection over the wireless communication channel between device 140 (FIG. 1) and device 120 (FIG. 1), e.g., as described above.

As indicated at block 608, the method may include receiving mapping information mapping the sink device to a WLAN AP. For example, controller 145 (FIG. 1) may receive the mapping information mapping device 120 (FIG. 1) to AP 170 (FIG. 1), e.g., as described above.

In some demonstrative embodiments, as indicated at block 610, the method may include receiving the mapping information prior to establishment of the peer-to-peer connection. For example, controller 145 (FIG. 1) may receive the mapping information prior to establishment of the peer-to-peer connection, e.g., as described above.

In other demonstrative embodiments, as indicated by arrow 603, the method may include receiving the mapping information after the establishment of the peer-to-peer connection between the source device and the sink device, e.g., as described below with reference to blocks 602 and 606.

As indicated at block 602, the method may include generating a message including the mapping information. For example, controller 125 (FIG. 1) may generate the message including the mapping information, e.g., as described above.

As indicated at block 606, the method may include sending the message to the source device via the peer-to-peer connection. For example, controller 125 (FIG. 1) may send the message to device 140 (FIG. 1) via the peer-to-peer connection, e.g., as described above.

As indicated at block 612, the method may include communicating WLAN traffic with the WLAN AP. For example, controller 145 (FIG. 1) may communicate the WLAN traffic with AP 170 (FIG. 1), e.g., as described above.

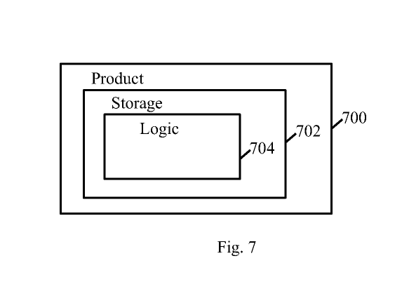

Reference is made to FIG. 7, which schematically illustrates a product of manufacture 700, in accordance with some demonstrative embodiments. Product 700 may include a non-transitory machine-readable storage medium 702 to store logic 704, which may be used, for example, to perform at least part of the functionality of device 120 (FIG. 1), device 140 (FIG. 1), controller 125 (FIG. 1), and/or controller 145 (FIG. 1), to perform one or more of the operations of the connectivity schemes of FIGS. 2, 3, 4 and/or 5, and/or to perform one or more operations of the method of FIG. 6. The phrase “non-transitory machine-readable medium” is directed to include all computer-readable media, with the sole exception being a transitory propagating signal.

In some demonstrative embodiments, product 700 and/or machine-readable storage medium 702 may include one or more types of computer-readable storage media capable of storing data, including volatile memory, non-volatile memory, removable or non-removable memory, erasable or non-erasable memory, writeable or re-writeable memory, and the like. For example, machine-readable storage medium 702 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 704 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 704 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

### EXAMPLES

The following examples pertain to further embodiments.

Example 1 includes a source device comprising a radio to establish a peer to peer connection over a wireless communication channel between the source device and a sink device, the peer to peer connection to communicate from the source device to the sink device content to be displayed on a display device; and a controller to receive mapping information to map the sink device to a Wireless Local Area Network (WLAN) Access Point (AP), the controller to communicate WLAN traffic with the WLAN AP during the peer to peer connection.

Example 2 includes the subject matter of Example 1, and optionally, wherein the radio is to receive the mapping information from the sink device via the peer to peer connection.

Example 3 includes the subject matter of Example 2, and optionally, wherein the radio is to receive the mapping information in a real time streaming protocol (RTSP) message from the sink device.

Example 4 includes the subject matter of Example 1, and optionally, wherein the radio is to receive the mapping information in a proximity discovery message.

Example 5 includes the subject matter of Example 1, and optionally, wherein the controller is to receive the mapping information prior to establishment of the peer to peer connection.

Example 6 includes the subject matter of any one of Examples 1-5, and optionally, comprising a memory to store the mapping information.

Example 7 includes the subject matter of any one of Examples 1-6, and optionally, wherein the mapping information is to map the sink device to a single WLAN AP.

Example 8 includes the subject matter of any one of Examples 1-7, and optionally, wherein the mapping information comprises a mapping between an identifier of the sink device and an identifier of the WLAN AP.

Example 9 includes the subject matter of Example 8, and optionally, wherein the identifier of the WLAN AP comprises a Basic Service Set Identifier (BSSID) of the WLAN AP.

Example 10 includes the subject matter of any one of Examples 1-9, and optionally, wherein, during the peer to peer connection, the controller is to communicate the WLAN traffic only with the WLAN AP.

Example 11 includes the subject matter of any one of Examples 1-10, and optionally, wherein the controller is to establish a WLAN link with the WLAN AP based on the mapping information.

Example 12 includes the subject matter of any one of Examples 1-11, and optionally, wherein the controller is to communicate with another WLAN AP prior to establishing the peer to peer connection, and to switch from the another WLAN AP to the WLAN AP.

Example 13 includes the subject matter of any one of Examples 1-12, and optionally the source device being a Miracast source or a Wireless Display source.

Example 14 includes the subject matter of any one of Examples 1-13, and optionally, comprising one or more antennas; a memory; and a processor.

Example 15 includes a sink device comprising a communication interface to establish a peer to peer connection with a source device via a wireless communication link, the peer to peer connection to communicate from the source device to the sink device content to be displayed on a display device; and a controller to generate a message including mapping information to map the sink device to a Wireless Local Area Network (WLAN) Access Point (AP), the controller to send the message to the source device.

Example 16 includes the subject matter of Example 15, and optionally, wherein the communication interface comprises a wireless radio.

Example 17 includes the subject matter of Example 16, and optionally, wherein the radio is to communicate directly with the source device via a direct wireless link between the sink device and the source device.

Example 18 includes the subject matter of Example 16, and optionally, wherein the radio is to communicate with the source device via a wireless link between the sink device and the WLAN AP.

Example 19 includes the subject matter of Example 15 being connected to the WLAN AP via a wired link, the communication interface to establish the peer to peer connection over the wired link.

Example 20 includes the subject matter of any one of Examples 15-19, and optionally, wherein the controller is to send the mapping information to the source device via the peer to peer connection.

Example 21 includes the subject matter of Example 20, and optionally, wherein the message comprises a real time streaming protocol (RTSP) message.

Example 22 includes the subject matter of any one of Examples 15-19, and optionally, wherein the message comprises a proximity discovery message.

Example 23 includes the subject matter of any one of Examples 15-22, and optionally, wherein the mapping information is to map the sink device to a single WLAN AP.

Example 24 includes the subject matter of any one of Examples 15-23, and optionally, wherein the mapping information comprises a mapping between an identifier of the sink device and an identifier of the WLAN AP.

Example 25 includes the subject matter of Example 24, and optionally, wherein the identifier of the WLAN AP comprises a Basic Service Set Identifier (BSSID) of the WLAN AP.

Example 26 includes the subject matter of any one of Examples 15-25, and optionally, the sink device being integrated with the WLAN AP in a sink-AP device.

Example 27 includes the subject matter of any one of Examples 15-26 being a Miracast sink or a Wireless Display sink.

Example 28 includes the subject matter of any one of Examples 15-27, and optionally, comprising one or more antennas; a memory; and a processor.

Example 29 includes a method to be performed at a source device, the method comprising establishing a peer to peer connection over a wireless communication channel between the source device and a sink device, the peer to peer connection to communicate from the source device to the sink device content to be displayed on a display device; receiving mapping information to map the sink device to a Wireless Local Area Network (WLAN) Access Point (AP); and communicating WLAN traffic with the WLAN AP during the peer to peer connection.

Example 30 includes the subject matter of Example 29, and optionally, comprising receiving the mapping information from the sink device via the peer to peer connection.

Example 31 includes the subject matter of Example 30, and optionally, comprising receiving the mapping information in a real time streaming protocol (RTSP) message from the sink device.

Example 32 includes the subject matter of Example 29, and optionally, comprising receiving the mapping information in a proximity discovery message.

Example 33 includes the subject matter of Example 29, and optionally, comprising receiving the mapping information prior to establishment of the peer to peer connection.

Example 34 includes the subject matter of any one of Examples 29-33, and optionally, comprising storing the mapping information.

Example 35 includes the subject matter of any one of Examples 29-34, and optionally, wherein the mapping information is to map the sink device to a single WLAN AP.

Example 36 includes the subject matter of any one of Examples 29-35, and optionally, wherein the mapping information comprises a mapping between an identifier of the sink device and an identifier of the WLAN AP.

Example 37 includes the subject matter of Example 36, and optionally, wherein the identifier of the WLAN AP comprises a Basic Service Set Identifier (BSSID) of the WLAN AP.

Example 38 includes the subject matter of any one of Examples 29-37, and optionally, comprising, during the peer to peer connection, communicating the WLAN traffic only with the WLAN AP.

Example 39 includes the subject matter of any one of Examples 29-38, and optionally, comprising establishing a WLAN link with the WLAN AP based on the mapping information.

Example 40 includes the subject matter of any one of Examples 29-39, and optionally, comprising communicating with another WLAN AP prior to establishing the peer to peer connection, and switching from the another WLAN AP to the WLAN AP.

Example 41 includes the subject matter of any one of Examples 29-40, and optionally, wherein the source device is a Miracast source or a Wireless Display source.

Example 42 includes a method to be performed at a sink device, the method comprising establishing a peer to peer connection with a source device via a wireless communication link, the peer to peer connection to communicate from the source device to the sink device content to be displayed on a display device; generating a message including mapping information to map the sink device to a Wireless Local Area Network (WLAN) Access Point (AP); and sending the message to the source device.

Example 43 includes the subject matter of Example 42, and optionally, comprising communicating directly with the source device via a direct wireless link between the sink device and the source device.

Example 44 includes the subject matter of Example 42, and optionally, comprising communicating with the source device via a wireless link between the sink device and the WLAN AP.

Example 45 includes the subject matter of Example 42, and optionally, comprising establishing the peer to peer connection over a wired link between the sink device and the WLAN AP.

Example 46 includes the subject matter of any one of Examples 42-45, and optionally, comprising sending the mapping information to the source device via the peer to peer connection.

Example 47 includes the subject matter of Example 46, and optionally, wherein the message comprises a real time streaming protocol (RTSP) message.

Example 48 includes the subject matter of any one of Examples 42-45, and optionally, wherein the message comprises a proximity discovery message.

Example 49 includes the subject matter of any one of Examples 42-48, and optionally, wherein the mapping information is to map the sink device to a single WLAN AP.

Example 50 includes the subject matter of any one of Examples 42-49, and optionally, wherein the mapping information comprises a mapping between an identifier of the sink device and an identifier of the WLAN AP.

Example 51 includes the subject matter of Example 50, and optionally, wherein the identifier of the WLAN AP comprises a Basic Service Set Identifier (BSSID) of the WLAN AP.

Example 52 includes the subject matter of any one of Examples 42-51, and optionally, wherein the sink device is integrated with the WLAN AP in a sink-AP device.

Example 53 includes the subject matter of any one of Examples 42-52, and optionally, wherein the sink device is a Miracast sink or a Wireless Display sink.

Example 54 includes a product including one or more tangible computer-readable non-transitory storage media comprising computer-executable instructions operable to, when executed by at least one computer processor, enable the at least one computer processor to implement a method at a source device, the method comprising establishing a peer to peer connection over a wireless communication channel between the source device and a sink device, the peer to peer connection to communicate from the source device to the sink device content to be displayed on a display device; receiving mapping information to map the sink device to a Wireless Local Area Network (WLAN) Access Point (AP); and communicating WLAN traffic with the WLAN AP during the peer to peer connection.

Example 55 includes the subject matter of Example 54, and optionally, wherein the method comprises receiving the mapping information from the sink device via the peer to peer connection.

Example 56 includes the subject matter of Example 55, and optionally, wherein the method comprises receiving the mapping information in a real time streaming protocol (RTSP) message from the sink device.

Example 57 includes the subject matter of Example 54, and optionally, wherein the method comprises receiving the mapping information in a proximity discovery message.

Example 58 includes the subject matter of Example 54, and optionally, wherein the method comprises receiving the mapping information prior to establishment of the peer to peer connection.

Example 59 includes the subject matter of any one of Examples 54-58, and optionally, wherein the method comprises storing the mapping information.

Example 60 includes the subject matter of any one of Examples 54-59, and optionally, wherein the mapping information is to map the sink device to a single WLAN AP.

Example 61 includes the subject matter of any one of Examples 54-60, and optionally, wherein the mapping information comprises a mapping between an identifier of the sink device and an identifier of the WLAN AP.

Example 62 includes the subject matter of Example 61, and optionally, wherein the identifier of the WLAN AP comprises a Basic Service Set Identifier (BSSID) of the WLAN AP.

Example 63 includes the subject matter of any one of Examples 54-62, and optionally, wherein the method comprises, during the peer to peer connection, communicating the WLAN traffic only with the WLAN AP.

Example 64 includes the subject matter of any one of Examples 54-63, and optionally, wherein the method comprises establishing a WLAN link with the WLAN AP based on the mapping information.

Example 65 includes the subject matter of any one of Examples 54-64, and optionally, wherein the method comprises communicating with another WLAN AP prior to establishing the peer to peer connection, and switching from the another WLAN AP to the WLAN AP.

Example 66 includes the subject matter of any one of Examples 54-65, and optionally, wherein the source device is a Miracast source or a Wireless Display source.

Example 67 includes a product including one or more tangible computer-readable non-transitory storage media comprising computer-executable instructions operable to, when executed by at least one computer processor, enable the at least one computer processor to implement a method at a sink device, the method comprising establishing a peer to peer connection with a source device via a wireless communication link, the peer to peer connection to communicate from the source device to the sink device content to be displayed on a display device; generating a message including mapping information to map the sink device to a Wireless Local Area Network (WLAN) Access Point (AP); and sending the message to the source device.

Example 68 includes the subject matter of Example 67, and optionally, wherein the method comprises communicating directly with the source device via a direct wireless link between the sink device and the source device.

Example 69 includes the subject matter of Example 67, and optionally, wherein the method comprises communicating with the source device via a wireless link between the sink device and the WLAN AP.

Example 70 includes the subject matter of Example 67, and optionally, wherein the method comprises establishing the peer to peer connection over a wired link between the sink device and the WLAN AP.

Example 71 includes the subject matter of any one of Examples 67-70, and optionally, wherein the method comprises sending the mapping information to the source device via the peer to peer connection.

Example 72 includes the subject matter of Example 71, and optionally, wherein the message comprises a real time streaming protocol (RTSP) message.

Example 73 includes the subject matter of any one of Examples 67-70, and optionally, wherein the message comprises a proximity discovery message.

Example 74 includes the subject matter of any one of Examples 67-73, and optionally, wherein the mapping information is to map the sink device to a single WLAN AP.

Example 75 includes the subject matter of any one of Examples 67-74, and optionally, wherein the mapping information comprises a mapping between an identifier of the sink device and an identifier of the WLAN AP.

Example 76 includes the subject matter of Example 75, and optionally, wherein the identifier of the WLAN AP comprises a Basic Service Set Identifier (BSSID) of the WLAN AP.

Example 77 includes the subject matter of any one of Examples 67-76, and optionally, wherein the sink device is integrated with the WLAN AP in a sink-AP device.

Example 78 includes the subject matter of any one of Examples 67-77, and optionally, wherein the sink device is a Miracast sink or a Wireless Display sink.

Example 79 includes an apparatus comprising means for establishing at a source device a peer to peer connection over a wireless communication channel between the source device and a sink device, the peer to peer connection to communicate from the source device to the sink device content to be displayed on a display device; means for receiving mapping information to map the sink device to a Wireless Local Area Network (WLAN) Access Point (AP); and means for communicating WLAN traffic with the WLAN AP during the peer to peer connection.

Example 80 includes the subject matter of Example 79, and optionally, comprising means for receiving the mapping information from the sink device via the peer to peer connection.

Example 81 includes the subject matter of Example 80, and optionally, comprising means for receiving the mapping information in a real time streaming protocol (RTSP) message from the sink device.

Example 82 includes the subject matter of Example 79, and optionally, comprising means for receiving the mapping information in a proximity discovery message.

Example 83 includes the subject matter of Example 79, and optionally, comprising means for receiving the mapping information prior to establishment of the peer to peer connection.

Example 84 includes the subject matter of any one of Examples 79-83, and optionally, comprising means for storing the mapping information.

Example 85 includes the subject matter of any one of Examples 79-84, and optionally, wherein the mapping information is to map the sink device to a single WLAN AP.

Example 86 includes the subject matter of any one of Examples 79-85, and optionally, wherein the mapping information comprises a mapping between an identifier of the sink device and an identifier of the WLAN AP.

Example 87 includes the subject matter of Example 86, and optionally, wherein the identifier of the WLAN AP comprises a Basic Service Set Identifier (BSSID) of the WLAN AP.

Example 88 includes the subject matter of any one of Examples 79-87, and optionally, comprising means for, during the peer to peer connection, communicating the WLAN traffic only with the WLAN AP.

Example 89 includes the subject matter of any one of Examples 79-88, and optionally, comprising means for establishing a WLAN link with the WLAN AP based on the mapping information.

Example 90 includes the subject matter of any one of Examples 79-89, and optionally, comprising means for communicating with another WLAN AP prior to establishing the peer to peer connection, and switching from the another WLAN AP to the WLAN AP.

Example 91 includes the subject matter of any one of Examples 79-90, and optionally, wherein the source device is a Miracast source or a Wireless Display source.

Example 92 includes an apparatus comprising means for establishing at a sink device a peer to peer connection with a source device via a wireless communication link, the peer to peer connection to communicate from the source device to the sink device content to be displayed on a display device; means for generating a message including mapping information to map the sink device to a Wireless Local Area Network (WLAN) Access Point (AP); and means for sending the message to the source device.

Example 93 includes the subject matter of Example 92, and optionally, comprising means for communicating directly with the source device via a direct wireless link between the sink device and the source device.

Example 94 includes the subject matter of Example 92, and optionally, comprising means for communicating with the source device via a wireless link between the sink device and the WLAN AP.

Example 95 includes the subject matter of Example 92, and optionally, comprising means for establishing the peer to peer connection over a wired link between the sink device and the WLAN AP.

Example 96 includes the subject matter of any one of Examples 92-95, and optionally, comprising means for sending the mapping information to the source device via the peer to peer connection.

Example 97 includes the subject matter of Example 96, and optionally, wherein the message comprises a real time streaming protocol (RTSP) message.

Example 98 includes the subject matter of any one of Examples 92-95, and optionally, wherein the message comprises a proximity discovery message.

Example 99 includes the subject matter of any one of Examples 92-98, and optionally, wherein the mapping information is to map the sink device to a single WLAN AP.

Example 100 includes the subject matter of any one of Examples 92-99, and optionally, wherein the mapping information comprises a mapping between an identifier of the sink device and an identifier of the WLAN AP.

Example 101 includes the subject matter of Example 100, and optionally, wherein the identifier of the WLAN AP comprises a Basic Service Set Identifier (BSSID) of the WLAN AP.

Example 102 includes the subject matter of any one of Examples 92-101, and optionally, wherein the sink device is integrated with the WLAN AP in a sink-AP device.

Example 103 includes the subject matter of any one of Examples 92-102, and optionally, wherein the sink device is a Miracast sink or a Wireless Display sink.

Functions, operations, components and/or features described herein with reference to one or more embodiments, may be combined with, or may be utilized in combination with, one or more other functions, operations, components and/or features described herein with reference to one or more other embodiments, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A source device comprising:
a radio to establish a peer to peer connection over a wireless communication channel between said source device and a sink device, the peer to peer connection to communicate from the source device to the sink device content to be displayed on a display device; and
a controller to receive mapping information to map said sink device to a Wireless Local Area Network (WLAN) Access Point (AP), said controller to communicate WLAN traffic with said WLAN AP during said peer to peer connection.

2. The source device of claim 1, wherein said radio is to receive said mapping information from said sink device via said peer to peer connection.

3. The source device of claim 2, wherein said radio is to receive said mapping information in a real time streaming protocol (RTSP) message from said sink device.

4. The source device of claim 1, wherein said radio is to receive said mapping information in a proximity discovery message.

5. The source device of claim 1, wherein said controller is to receive said mapping information prior to establishment of said peer to peer connection.

6. The source device of claim 1, wherein said mapping information is to map said sink device to a single WLAN AP.

7. The source device of claim 1, wherein said mapping information comprises a mapping between an identifier of said sink device and an identifier of said WLAN AP.

8. The source device of claim 7, wherein the identifier of said WLAN AP comprises a Basic Service Set Identifier (BSSID) of said WLAN AP.

9. The source device of claim 1, wherein, during said peer to peer connection, said controller is to communicate said WLAN traffic only with said WLAN AP.

10. The source device of claim 1, wherein said controller is to establish a WLAN link with said WLAN AP based on said mapping information.

11. The source device of claim 1, wherein said controller is to communicate with another WLAN AP prior to establishing said peer to peer connection, and to switch from the another WLAN AP to said WLAN AP.

12. The source device of claim 1 comprising:
one or more antennas;
a memory; and
a processor.

13. A sink device comprising:
a communication interface to establish a peer to peer connection with a source device via a wireless communication link, the peer to peer connection to communicate from the source device to the sink device content to be displayed on a display device; and
a controller to generate a message including mapping information to map said sink device to a Wireless Local Area Network (WLAN) Access Point (AP), said controller to send said message to said source device.

14. The sink device of claim 13, wherein said communication interface comprises a wireless radio.

15. The sink device of claim 13 being connected to said WLAN AP via a wired link, said communication interface to establish said peer to peer connection over said wired link.

16. The sink device of claim 13, wherein said controller is to send said mapping information to said source device via said peer to peer connection.

17. The sink device of claim 13, wherein said mapping information is to map said sink device to a single WLAN AP.

18. The sink device of claim 13, wherein said mapping information comprises a mapping between an identifier of said sink device and an identifier of said WLAN AP.

19. The sink device of claim 13 being integrated with said WLAN AP in a sink-AP device.

20. A product including one or more tangible computer-readable non-transitory storage media comprising computer-executable instructions operable to, when executed by at least one computer processor, enable the at least one computer processor to implement a method at a source device, the method comprising:
establishing a peer to peer connection over a wireless communication channel between said source device and a sink device, the peer to peer connection to communicate from the source device to the sink device content to be displayed on a display device;
receiving mapping information to map said sink device to a Wireless Local Area Network (WLAN) Access Point (AP); and
communicating WLAN traffic with said WLAN AP during said peer to peer connection.

21. The product of claim 20, wherein said method comprises receiving said mapping information from said sink device via said peer to peer connection.

22. The product of claim 20, wherein said method comprises receiving said mapping information in a proximity discovery message.

23. A product including one or more tangible computer-readable non-transitory storage media comprising computer-executable instructions operable to, when executed by at least one computer processor, enable the at least one computer processor to implement a method at a sink device, the method comprising:
establishing a peer to peer connection with a source device via a wireless communication link, the peer to peer connection to communicate from the source device to the sink device content to be displayed on a display device;
generating a message including mapping information to map said sink device to a Wireless Local Area Network (WLAN) Access Point (AP); and
sending said message to said source device.

24. The product of claim 23, wherein said method comprises communicating directly with said source device via a direct wireless link between said sink device and said source device.

25. The product of claim 23, wherein said mapping information is to map said sink device to a single WLAN AP.
